(19) United States
(12) Patent Application Publication
(10) Pub. No.: US 2021/0404231 A1
(43) Pub. Date: Dec. 30, 2021

(54) Adjustable Hinge

(71) Applicant: ERA Home Security Limited, Wolverhampton (GB)

(72) Inventors: Robert Menear, Wolverhampton (GB); Ray Li, Wolverhampton (GB)

(73) Assignee: ERA Home Security Limited, Wolverhampton (GB)

(21) Appl. No.: 17/357,379

(22) Filed: Jun. 24, 2021

(30) Foreign Application Priority Data
Jun. 25, 2020 (GB) 2009733.3

(51) Int. Cl. E05D 7/04

(52) U.S. Cl. CPC E05D 7/0423; E05D 2007/0469; E05Y 2900/148; E05Y 2900/132

(57) ABSTRACT

A hinge for a door or window has a door or window and a frame. The hinge has a first and a second hinge leaf pivotably connectable to each other. The first hinge leaf is connectable to the door/window or frame. The second hinge leaf is adjustably connectable to a base in turn connectable to the other of said door/window or frame. The second hinge leaf extends from the base in a first direction and the hinge comprises an adjustment mechanism with a cam and follower configured so that rotating the cam moves the second hinge leaf, relative to the base, in the first direction.

### TECHNICAL FIELD

The invention relates to hinges, and more specifically to hinges for doors and/or windows.

### BACKGROUND

A wide range of hinges is commonly available for doors and windows for a range of different specific purposes, each with varying requirements for strength, security and aesthetics. It is known in the field that a high level of adjustability in a hinge is desirable in order to simplify installation of the door/window within the frame. Misaligned hinges are often the cause of door/windows not closing properly which can lead to damage of the door/window and frame, to security hardware being misaligned or inoperable, or to ineffective sealing of the door/window and thus water ingress or increased heat loss through the installation. Ensuring the door is perfectly aligned is time-consuming for the installer, thus many hinges offer varying degrees of adjustability to ensure the door can be aligned correctly within the frame once installed.

Hinges connected to the outer faces of the door/window, such as those for uPVC doors and windows are often bulky and can be aesthetically unappealing. In some door and window installations, such as for solid wood or composite material doors/windows, it is desirable to conceal some or all of the hinge mechanism. This leads to a need for small parts in order to fit within recesses and mortices in the door/window and frame.

Providing suitable levels of adjustability, especially with the need for size reduction, increases the complexity of the hinge and the unit cost. Commonly available hinges on the market thus have to balance these two factors.

U.S. Pat. No. 8,429,794 describes a hinge suitable for use with solid and/or composite doors/windows which is adjustable in only two dimensions. European Patent No. 2 589 734 describes a hinge which is adjustable in three dimensions, but which is more complex and thus has more potential points of failure and is more expensive to produce.

The present invention attempts to resolve and/or ameliorate one or more of the problems with hinges for door/windows and/or provide a valuable alternative.

### SUMMARY OF INVENTION

According to a first aspect of the invention, there is provided a hinge for a door and/or window comprising a door/window and a door/window frame. The hinge may comprise a first and a second hinge leaf pivotably connectable to each other; the first hinge leaf being connectable to one of said door/window and door/window frame; and the second hinge leaf being adjustably connectable to a base, the base being connectable to the other of said door/window and door/window frame leaf. The second hinge leaf may extend from the base in a first direction. The hinge may comprise an adjustment mechanism. The adjustment mechanism may comprise a cam and follower. The cam and follower may be configured so that rotating the cam moves the second hinge leaf, relative to the base, in the first direction.

The inventors have found that an adjustment mechanism comprising a cam and follower is a simple, reliable and robust way of providing a high level of adjustment of the hinge. The adjustment mechanism may comprise a compression adjustment mechanism. For example, a compression adjustment mechanism may be configured such that the first direction is a compression direction. The compression direction is the direction which the second hinge leaf must move in order to, in use, adjust the force applied to any compression seals or gaskets provided in a door or window assembly. Door and window assemblies typically comprise seals or gaskets located between the door and/or window and the door and/or window frame which require a small amount of compression to effectively seal. The compression adjustment mechanism may, in use, adjust the position of the door and/or window such that sufficient compression is exerted on or by the seals and gaskets to provide an effective seal. The compression direction may be perpendicular to the plane of a door and or window frame.

The first direction may be an extension direction (i.e. the direction which the second hinge leaf extends from the base) such that the second hinge leaf is extendable relative to the base. In use, the compression direction and the extension direction may be the same.

The position of the second hinge leaf relative to the base may be continuously adjustable by rotating the cam. The position of the second hinge leaf relative to the base may depend upon the orientation of the cam. The second hinge leaf may be movable between a fully extended position and a fully retracted position. Preferably, the cam is an eccentric circular cam. Alternatively, the cam may be non-circular. The adjustment of the hinge is simple, since only half a rotation of the cam may be necessary to move the second hinge leaf from a fully extended position to a fully retracted position.

The first and second hinge leafs are pivotably connectable to each other, and thus may define a hinge axis therebetween. The adjustment mechanism may be configured to move the hinge axis e.g. relative to the base. The first and second hinge leafs may comprise barrel portions. The barrel portions may be connectable by a hinge pin and configured to allow rotation of one or both of the first and second hinge leafs relative to the hinge pin. Optionally, the hinge pin may be integrally formed with the first or second hinge leaf.

The first direction may be in a horizontal plane. The first direction may be a compression direction and/or perpendicular to the plane of a door/window frame in use. For example, by moving the second hinge leaf in the first direction, the door/window would be moved in the first direction. This movement may, for example, be used to adjust the level of compression of seals or gaskets which may be provided. The invention thus provides a simple hinge mechanism by which the weather proofing and/or energy efficiency of a door/window can be improved.

The follower may be located in the second hinge leaf. The cam may be connectable to the base. The cam and follower may be configured such that rotating the cam applies a driving force to the follower. The driving force may be in the first direction, thereby moving the second hinge leaf in said first direction. In an alternative embodiment, the configuration may be reversed, with the cam connected to the second hinge leaf and the follower provided on or connected to the base.

The follower may comprise a slot or opening. The cam may be located within the slot or opening. The cam and the slot or opening may be configured such that rotating the cam applies a driving force to the sides of the slot. The slot may be configured to permit relative movement of the cam and follower in a further direction, perpendicular to the first direction e.g. the slot may be configured to permit movement of the second hinge leaf in a further direction relative to the base. In some embodiments, the follower may comprise a surface or wall rather than a slot or opening. Optionally, the follower comprises a pair of parallel surfaces or walls, such that the cam can act apply a driving force both forwards and backwards.

The adjustment mechanism may comprise a locking mechanism. The locking mechanism may be configured to prevent rotation of the cam. For example, the locking mechanism may prevent the rotation of the cam when engaged and may need to be disengaged before the cam is adjusted. Such configurations prevent the position of the cam and follower from changing after they have been set to the correct position. The locking mechanism may thus prevent the hinge becoming misaligned after installation, for example due expansion/contraction stresses, repeat use, or material wear and fatigue.

The locking mechanism may comprise one or more cam recesses on a surface of the cam. The locking mechanism may comprise one or more teeth configured to engage the one or more cam recesses when aligned therewith. In an alternative embodiment, the cam may comprise one or more teeth configured to engage one or more corresponding recesses in the locking mechanism. When the one or more teeth and recesses are engaged, rotation of the cam may be prevented.

In some embodiments, the cam recesses comprise a plurality of radial cam recesses configured such that rotating the cam moves the radial cam recesses into and out of engagement with the one or more teeth. Such embodiments are desirable, since the locking mechanism can prevent rotation of the cam in multiple orientations. In some embodiments, the locking mechanism may provide stepwise adjustability of the cam and follower. Thus a separate adjustment and locking step is not required when adjusting the hinge in use.

Additionally or alternatively, the locking mechanism may comprise a screw e.g. a grub screw. The screw may be configured to resist movement of the adjustment mechanism when tightened. The screw may be configured to clamp against the second hinge leaf to resist movement thereof.

The plurality of radial cam recesses may be located around a drive surface provided in the cam, the drive surface being configured to receive a tool for driving the rotation of the cam. The drive surface may be configured to receive an Allen key (hex key), screwdriver, Torx® drive, square drive (Robertson), or similar tool. The drive surface may be configured to have an anti-tamper drive surface.

The cam may be movable axially, for example, to disengage the locking mechanism. The locking mechanism may be configured such that a user pushes down on the cam to disengage the locking mechanism. The cam may comprise a biasing mechanism to bias the cam axially into a position wherein the locking mechanism is engaged. The biasing mechanism may comprise a spring. Thus the cam is automatically biased into a locked position to prevent unintended rotation of the cam e.g. after the cam orientation has been set. For example, the cam may be movable axially to disengage the tooth from the one or more cam recesses. The biasing member may bias the cam axially into a position wherein the tooth and one or more recesses are engaged.

In some embodiments, in use, the adjustment mechanism may be adjusted by inserting a tool such as an Allen key or screwdriver into the drive surface of the cam. The user then depresses the cam to disengage the locking mechanism and rotates the cam using the tool. The rotating cam applies a force to the follower, thereby moving the second hinge leaf relative to the base. Once the desired cam orientation has been reached, the user releases the pressure on the cam, which is thus biased into a position wherein the locking mechanism is engaged and the cam can no longer rotate.

In some embodiments, the hinge may comprise a lateral adjustment mechanism. The lateral adjustment mechanism may be configured to move the second hinge leaf in a second direction, perpendicular to the first direction. The second direction may be a lateral direction, relative to a door frame in use e.g. widthwise of the frame. The second direction may be a horizontal direction.

The lateral adjustment mechanism may be configured to pivot the second hinge leaf e.g. such that the hinge axis is moved in the second direction.

The lateral adjustment mechanism may comprise a first shaft having a screw thread engaged with the second hinge leaf; and a saddle configured so that the second hinge leaf rests against the saddle, wherein the first shaft is configured so that rotation of the first shaft pivots the first hinge leaf about the saddle.

The saddle may be located adjacent to, or at least partially define, an opening in the base. The second hinge leaf may extend through the opening in the base. The first shaft may be connected to an end of the second hinge leaf. The saddle may be spaced apart from the first shaft and/or located between the first shaft and the hinge axis.

The lateral adjustment mechanism may be configured so that rotation of the first shaft causes the second hinge leaf to travel along the screw thread on the first shaft. The first shaft may comprise a drive surface in an end thereof for receiving a tool (such as described previously) for driving the rotation of the first shaft. The first shaft may comprise a rounded cap. The rounded cap may be located within a lateral adjustment recess to retain the first shaft in position and allow rotation thereof. The first shaft may comprise a rounded cap on each end thereof, and each end may be located within corresponding lateral adjustment recesses. Thus, the first shaft can be retained in position without requiring mechanical fasteners, and while allowing the first shaft to rotate freely.

The lateral adjustment recess(es) may be elongate, and configured to permit the first shaft to travel lengthwise along the recess e.g. by sliding. The lateral adjustment recess(es) may be stadium shaped. The recess(es) may extend in the first direction. Thus, the first shaft may be held captive within the recess(es), but allowed to travel with the second hinge leaf when the user adjusts the position of the second hinge leaf in the first direction as described above. In some embodiments, the lateral adjustment recess or recesses may comprise a slot or slots.

The adjustment mechanism may further comprises an axial adjustment mechanism. The axial adjustment mechanism may be configured to move the second hinge leaf in a third direction, perpendicular to the first and second directions. The third direction may be an axial direction e.g. relative to the hinge axis. The third direction may be a vertical direction.

The axial adjustment mechanism may comprise a carriage. The carriage may be connectable to the base and to the second hinge leaf. The carriage may be movable in the third direction e.g. relative to the base. The adjustment mechanism (e.g. the compression adjustment mechanism) and the lateral adjustment mechanism may be located on the carriage.

The axial adjustment mechanism may comprise a second shaft having a screw thread. The screw thread on the second shaft may be engaged with a corresponding formation on the carriage. The axial adjustment mechanism may be configured so that rotation of the second shaft causes the carriage to travel along the screw thread on the second shaft.

The second shaft may be connectable to the base such that it is rotatable but unable to move axially or laterally. For example, the base may comprise an opening through which the second shaft extends, the opening comprising a shoulder or shoulders for engaging a circumferential groove on the second shaft. The axial adjustment mechanism may comprise a drive gear operatively engaged with a gear head on the second shaft, wherein rotation of the drive gear drives the rotation of the second shaft. The drive gear may have a gear axis at right angles relative to the axis of the second shaft. The drive gear and gear head may comprise bevel gears. The drive gear and gear head may comprise a worm drive. The drive gear may comprise a drive surface such as the drive surfaces described above.

In some embodiments, the adjustment mechanism may be configured so that all of the drive surfaces are located on the same surface of the base.

In some embodiments, the base may comprise a housing having a guide channel. The carriage may comprise a limiter located within the guide channel. The guide channel and limiter may be configured to guide the motion of the carriage relative to the housing in at least one direction. The guide channel may comprise a slot or aperture in the housing. The limiter may comprise a plate configured to slide within the slot or aperture in the third direction.

In some embodiments, the lateral adjustment recess described above may be located in the carriage, and optionally, in the carriage limiter. The lateral adjustment recess may be elongate and/or shaped as described above. Thus, when the user adjusts the adjustment mechanism (e.g. the compression adjustment mechanism), the second hinge leaf is able to move relative to the carriage without affecting either the lateral or axial adjustment mechanisms.

According to a second aspect of the invention, there is provided a door or window assembly comprising a door or window, a door or window frame and one or more hinges as describe above.

### BRIEF DESCRIPTION OF THE FIGURES

Embodiments of the invention will now be described, by way of example only, with reference to the following drawings, in which:

FIG. 1 is a perspective view of a hinge in an open orientation;

FIG. 2 is a perspective view of a hinge in a closed orientation;

FIG. 3 is an exploded diagram of the hinge of FIG. 1;

FIG. 4 is a close up view of a partial hinge with a fascia plate removed;

FIG. 5 is the close up view of FIG. 4 with a second housing removed;

FIG. 6 is an exploded diagram of a first side of an adjustment mechanism; and

FIG. 7 is the exploded diagram of FIG. 6 viewed from the opposite side.

### DETAILED DESCRIPTION

The invention is illustrated in the following Figures, which are meant to be exemplary and non-limiting, and in which like references are intended to refer to like or corresponding parts.

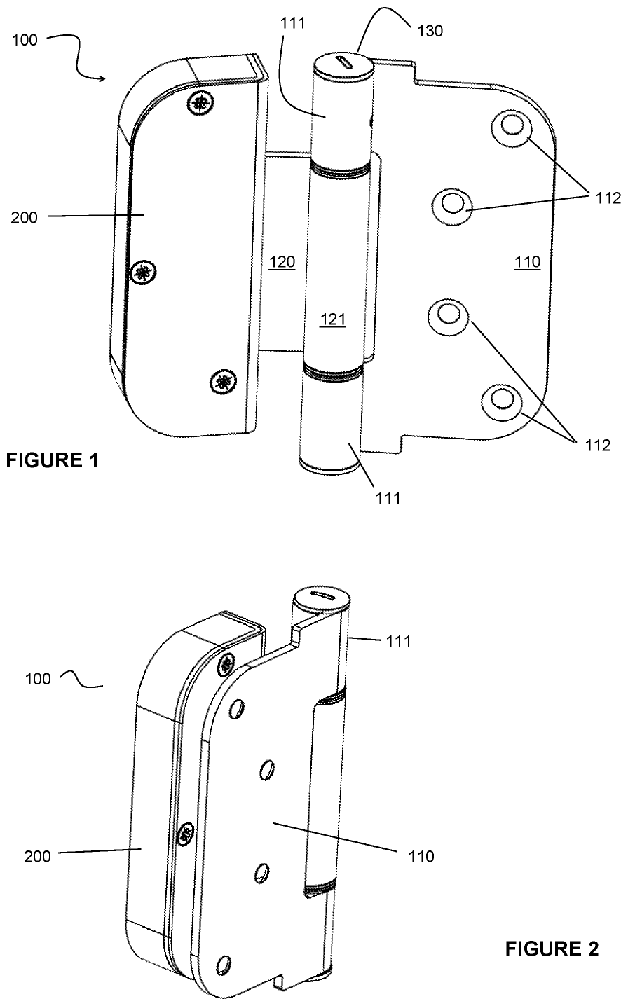

Turning now to FIGS. 1 and 2 there is shown a hinge 100 in perspective view. FIG. 1 shows the hinge 100 in an open orientation; FIG. 2 shows the same hinge 100 in a closed orientation. The hinge 100 is intended for a door or window assembly (not shown) comprising a pivoting door/window located within a door/window frame. For the ease of explanation, the terms ‘door’ and ‘door frame’ will be used throughout the description to refer to components of both door and window assemblies.

The hinge 100 has a first hinge leaf 110 and a second hinge leaf 120, which are pivotably connected to each other. The second hinge leaf 120 is adjustably connected to a base 200. The first hinge leaf 110 is connectable to either a door or a door frame and the base 200 is connectable to the other of the door or door frame. The hinge 100 has an adjustment mechanism for adjusting the position of the second hinge leaf 120 relative to the base 200, as will be described subsequently.

In the embodiment shown, the first and second hinge leafs 110, 120 have barrel portions 111, 121 which are aligned axially and receive a hinge pin assembly 130 therein to secure the first and second leafs together while allowing relative rotation. The hinge pin assembly 130 is of a conventional type, and may contain a shaft and one or more bushings, bearings or washers to ensure smooth movement of the leafs 110, 120. The hinge pin assembly 130 thus defines the hinge axis of the hinge 100 (i.e. the rotational axis of the first and second hinge leafs 110, 120).

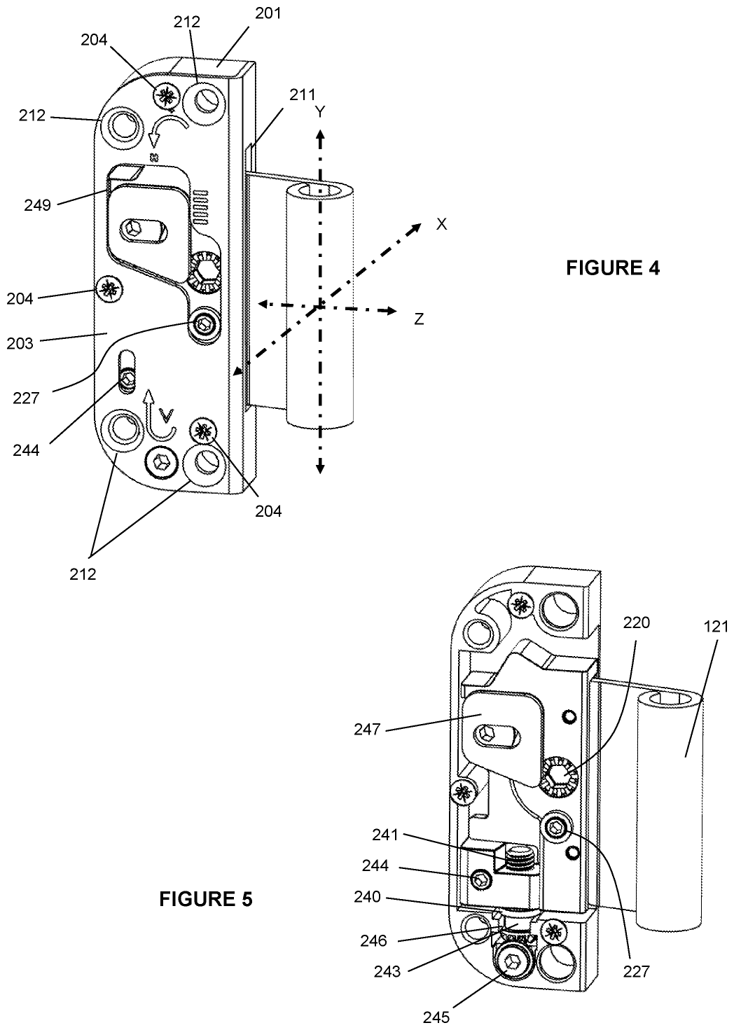

In use, the first hinge leaf 110 can be fitted to the end face of the door; either directly onto the surface or into a shallow recess such that the surface of the first hinge leaf lies flush with the end face surface. The first hinge leaf 110 can be secured with mechanical fasteners through the fixing holes 112. Equally, it will be understood that the base 200 can be fitted into a recess or mortice cut into the door frame and secured with mechanical fasteners through further fixing holes (212, see FIG. 4). It will be appreciated that the arrangement can be reversed such that the first hinge leaf 110 is connected to a door frame and the base 200 is connected to a door. The hinge 100 is configured such that when in the closed orientation, as shown in FIG. 2, the plane of the first hinge leaf 110 and the base 200 are approximately parallel. When closed, it will be appreciated that the majority of the hinge 100 is obscured from view, being hidden within the door and door frame, with the barrel portions 111, 121 exposed and projecting slightly from the door and door frame. As will be described below, by adjusting the adjustment mechanism, the second hinge leaf can be moved relative to the base. Consequently, the hinge axis and first hinge leaf are also moved. Since the first hinge leaf is connected to the door, adjustment of the second hinge leaf position thus adjusts the position of the door within the frame. As shown in FIG. 4, the hinge axis is movable in all three perpendicular axes. The axis Z corresponds to the directions perpendicular to the plane of the door frame. The position of the door can thus be adjusted to accommodate any misalignment of the hinges during installation so that the door can pivot smoothly and also ensure that the necessary compression is applied to any seals and gaskets provided.

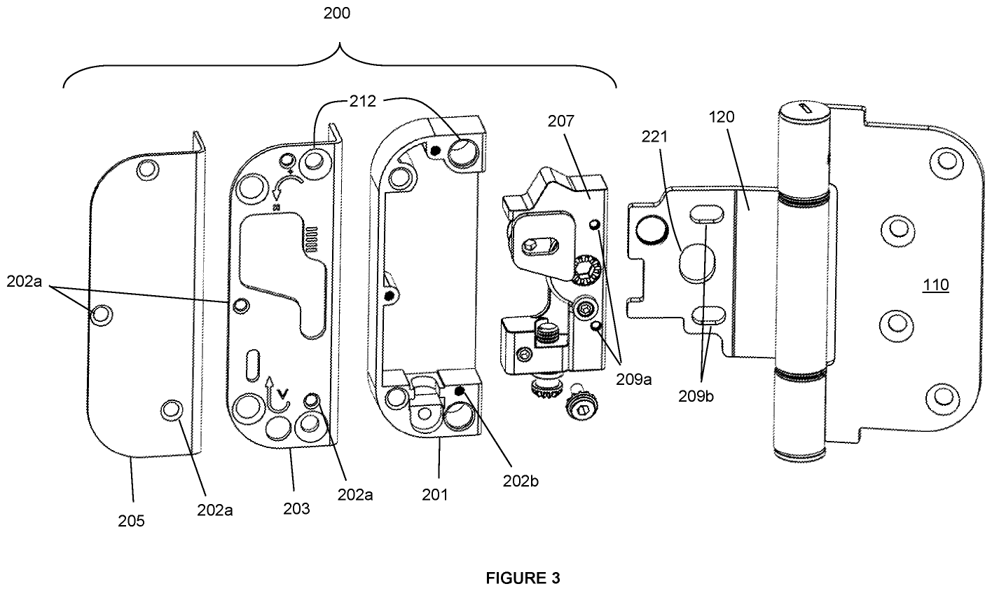

Turning now to FIGS. 3 and 4 there is shown an exploded view of the hinge 100, and further views of the base 200 partially disassembled. The base 200 is formed from a first housing 201, second housing 203 and a fascia plate 205. Mechanical fasteners 204 extend through holes 202a in the fascia plate 205 and second housing portion 203 to engage threaded holes 202b in the first housing 201. The mechanical fasteners 204 thus connect the fascia plate 205 to the first and second housings 201, 203. Thus the fascia plate 205 is removable by removing the mechanical fasteners 204 without the base 200 being detached from the frame. The fascia plate 205 is configured to conceal the adjustment mechanisms of the base as described herein, and thus prevent accidental adjustment or tampering with the set-up of the hinge 100. Because the mechanical fasteners 204 engage the first housing 201, the fasteners 204 and fascia plate 205 can be removed without affecting the second housing 203.

FIG. 4 shows the base with the fascia plate 205 removed. The first and second housings 201, 203 have fixing holes 212 through which further mechanical fasteners can be passed to secure the base 200 to a door frame. The fascia plate 205 covers the second housing 203 such that the internal components cannot be tampered with unless the fascia plate 205 is first removed.

The first and second housings 201, 203 define an internal volume which houses a carriage 207, which connects to the second hinge leaf 120. The base 200 has a leaf slot 211, formed in the second housing 203 and the fascia plate 205, and through which the second hinge leaf 120 extends.

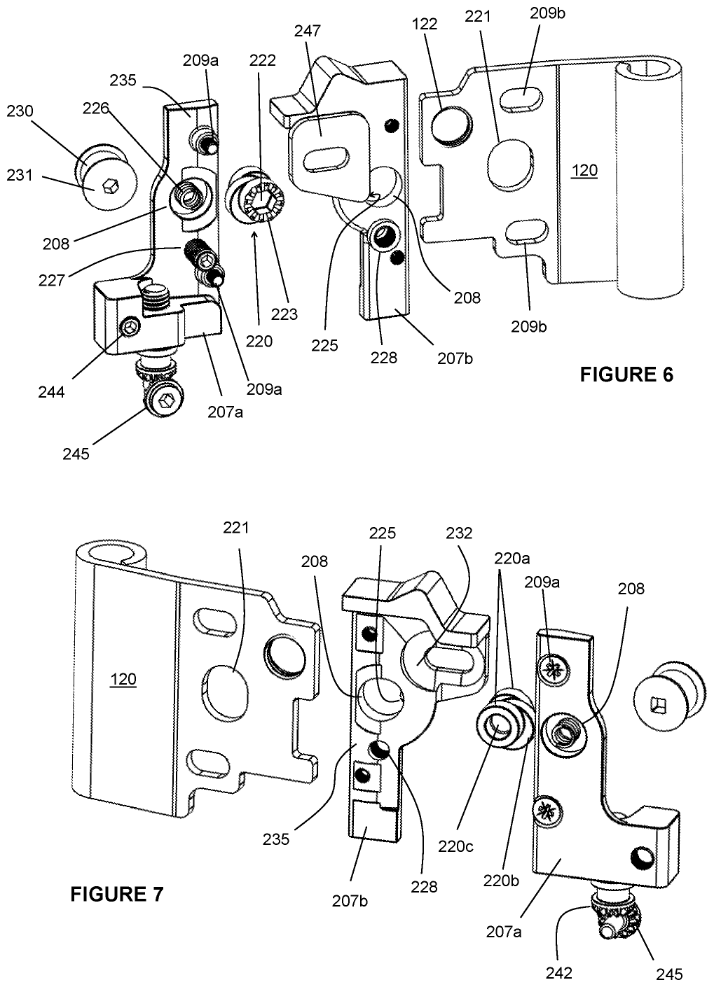

Turning now to FIGS. 5 to 7, the mechanism for adjusting the hinge 200 will be described. FIG. 5 shows the base 200 with the fascia plate 205 and the second housing 203 removed. FIGS. 6 and 7 show opposite sides of the internal mechanism in an exploded view.

The carriage 207 is formed of first and second carriage portions 207a, 207b. The second hinge leaf 120 is received within an opening in the carriage 207 defined between the first and second carriage portions 207a, 207b and retained in position via a pair of mechanical fasteners 209a which extend between the first and second carriage portions 207a, 207b and through slots 209b in the second hinge leaf 120. The slots 209b allow the second hinge portion 120 to move in the axis of the slots 209b relative to the carriage 207. This motion corresponds to the Z axis or direction as shown in FIG. 4. Thus, the hinge 100 is configured to allow the movement of the second hinge leaf 120, and specifically the barrel portion 121, relative to the base 200 in the direction Z.

The position of the second hinge leaf 120 is determined by an adjustment mechanism having a cam 220 comprising a pair of discs 220a and an eccentric circular cam surface 220b (alternative cam shapes could equally be used). Each disc 220a is received within a respective circular recess 208 in a respective carriage portion 207a, 207b to retain the cam 220 in position. The cam surface 220b is engaged with a follower in the form of a cam slot 221 in the second hinge leaf 120. The cam slot 221 has a width (in the Z axis) corresponding to the diameter of the cam surface 220b. A face of the cam 220 is provided with a drive surface 222 for receiving a driving tool. In the embodiment shown, the drive surface 222 is configured to receive an Allen key, but alternative drive surfaces could also be used. As the cam 220 rotates it applies a force to the sides of the cam slot 221 and thus drives the second hinge leaf in the Z axis/direction. The cam slot 221 is elongate and extends vertically (i.e. the Y axis), thus allowing the second hinge leaf 120 to rise and fall relative to the base 200, without affecting the position of the second hinge leaf 120 in the Z axis.

The adjustment mechanism also has a locking mechanism configured to prevent undesired or accidental rotation of the cam 220. Around the drive surface 222 are multiple radial cam recesses 223, such that the surface is ridged or castellated. The carriage 207 is provided with a tooth 225 which engages one or more of the radial cam recesses and prevents rotation thereof. In the embodiment shown, the tooth 225 is located on the rear of limiter 247 (described below) which partially overlies the recess 208 in the carriage portion 207b. The tooth 225 extends from the limiter 247 toward the recess 208, where it is then able to engage the radial cam recesses 223. The location of the tooth 225 on the limiter 247 is a convenient location, but it would be appreciated that the position of the tooth 225 on the carriage 207 could be changed without substantially changing the manner of operation.

The cam 220 has a spring 226 located within a channel 220c in the cam 220. The channel 220c is open at a first end facing the first housing 201, and is closed at the end comprising the drive surface 222 and radial cam recesses 223. The spring 226 bears against the surface of the first housing 201 and is configured to bias the cam 220 toward the tooth 225 in the limiter 247. The spring 226 thus ensures that the default position of the cam 220 corresponds to the engagement of the tooth 225 and the radial cam recesses 223 to prevent rotation thereof. The user, wishing to adjust the cam 220, presses down on the cam 220 against the action of the spring 226 to disengage the tooth 225 and the radial cam recesses 223.

The locking mechanism further has a grub screw 227 which is located within a threaded channel 228 which extends through the second carriage portion 207b and opens onto the second hinge leaf 120 when assembled. The grub screw 227 and threaded channel 228 are configured such that tightening the grub screw 227 clamps the second hinge leaf 120 against the first carriage portion 207a, helping to prevent unwanted movement of the second hinge leaf 120 in the Z direction.

In use, to adjust the position of the second hinge leaf 120, the user unscrews the grub screw 227 to release the second hinge leaf. The user then depresses the cam 220, against the biasing action of the spring 226, and rotates the cam 220 with an Allen key to drive the second hinge leaf 120 forwards and backwards in the Z direction. As the cam 220 rotates, the radial cam recesses 223 are moved into and out of alignment with the tooth 225 until the user releases the cam and the spring 226 biases the cam axially to engage the radial recesses 223 and the tooth 225.

With reference to FIGS. 4 to 7, there is also shown a lateral adjustment mechanism. The lateral adjustment mechanism is configured to move the second hinge leaf in a second direction, perpendicular to the first. As shown in FIG. 4, the lateral adjustment is in the X axis. This movement would move the door laterally (e.g. widthwise) in a door frame in use.

The lateral adjustment mechanism is provided by a shaft 230 which has a screw thread thereon engaged with the second hinge leaf 120, via aperture 122 which has a corresponding internal screw thread or engaging formation. The shaft 230 has a curved end cap 231 at each end which locate at one end within a lateral adjustment recess 232 formed in the carriage 207, and against the inside of the first housing 201 at the other end. The lateral adjustment recess 232 is approximately stadium shaped, thereby allowing the end cap 231 to slide lengthwise within the recess by the action of the adjustment mechanism described previously.

The carriage 207 has a saddle 235 formed thereon by way of angled or curved surfaces on the first and second carriage portions 207a, 207b adjacent to the opening formed therebetween and positioned on opposite sides of the second hinge leaf 120. The shaft 203 is configured so that rotation of the shaft causes the aperture 122 to travel along the shaft 230. Since the second hinge leaf 120 is located between the first and second carriage portions 207a, 207b, the second hinge leaf pivots about the saddle in a plane defined by the X-Z axes. This rotation causes the hinge axis to travel in the X axis. It will be appreciated that the path of travel of the hinge axis is not perfectly linear, but that the amount of curve in the path is negligible.

Returning now to FIGS. 4 and 5, there is shown an axial adjustment mechanism. The axial adjustment mechanism is configured to move the second hinge leaf 120 in a third direction, perpendicular to the first and second directions (i.e. in the axis Y). The axial adjustment mechanism includes the carriage 207 which is engaged with an axial shaft 240. The axial shaft 240 has a screw thread 241 engaged with an aperture in the carriage 207 and configured such that rotation of the axial shaft 240 causes the carriage to travel along the screw thread 241. The axial shaft 240 has a circumferential groove 243 formed therein which engages a shoulder 246 formed in the first housing 201 to retain the axial shaft 240 in position. The axial shaft 240 has a geared surface 242 at one end which is driven by a corresponding geared surface on a drive cog 245.

The drive cog 245 can be driven by an Allen key as described previously, and in turn drives the rotation of the axial shaft 240 and the axial movement of the carriage 207. Adjacent to the axial shaft 240 is a second grub screw 244 which extends through a channel in the carriage 207. The second grub screw 244 can be tightened in order to bear against the internal surface of the first housing 201 and resist axial movement (i.e. in the Y axis) of the carriage 207.

To ensure the axial movement (i.e. along the shaft 240, in the Y axis) is linear, the carriage 207 has a limiter 247, which is a raised plate portion. When assembled, the limiter 247 is located within a guide channel 249 provided in the second housing 203 of the base 200. The limiter 247 and guide channel 249 thus ensure that the carriage 207, and thus the door, only move in the axis Y when the drive cog 245 is rotated. As shown in FIGS. 6 and 7, the lateral adjustment recess 232 is provided on the internal face of the limiter 247 so that the adjustment in each axis is isolated from each other.

1. A hinge for a door or window comprising a door or window and a door or window frame, the hinge comprising:
a first and a second hinge leaf pivotably connectable to each other;
the first hinge leaf being connectable to one of said door or window and door or window frame; and
the second hinge leaf being adjustably connectable to a base, the base being connectable to the other of said door or window and door or window frame;
wherein
the second hinge leaf extends from the base in a first direction; and
where the hinge comprises an adjustment mechanism comprising a cam and follower configured so that rotating the cam moves the second hinge leaf, relative to the base, in the first direction.

2. The hinge according to claim 1, wherein the follower comprises a slot or opening located in the second hinge leaf and wherein the cam is located within the slot or opening.

3. The hinge according to claim 1, wherein the adjustment mechanism comprises a locking mechanism configured to prevent rotation of the cam.

4. The hinge according to claim 3, wherein the locking mechanism comprises one or more cam recesses on a surface of the cam, and one or more teeth configured to engage the one or more cam recesses when aligned therewith.

5. The hinge according to claim 4, wherein the cam recesses comprise a plurality of radial cam recesses configured such that rotating the cam moves the radial cam recesses into and out of engagement with the one or more teeth.

6. The hinge according to claim 5, wherein the plurality of radial cam recesses are located around a drive surface provided in the cam, the drive surface being configured to receive a tool for driving the rotation of the cam.

7. The hinge according to claim 4, wherein the cam is movable axially to disengage the one or more teeth from the one or more cam recesses, and wherein the cam comprises a biasing member to bias the cam axially into a position wherein the one or more teeth and one or more recesses are engaged.

8. The hinge according to claim 1, wherein the adjustment mechanism further comprises a lateral adjustment mechanism configured to move the second hinge leaf in a second direction, perpendicular to the first direction.

9. The hinge according to claim 8, wherein the lateral adjustment mechanism comprises:
a shaft having a screw thread engaged with the second hinge leaf; and
a saddle configured so that the second hinge leaf rests against the saddle,
wherein the shaft is configured so that rotation of the shaft pivots the first hinge leaf about the saddle.

10. The hinge according to claim 9, wherein the shaft comprises a rounded cap located within a lateral adjustment recess to retain the shaft in position and allow rotation thereof.

11. The hinge according to claim 10, wherein the adjustment mechanism further comprises an axial adjustment mechanism, configured to move the second hinge leaf in a third direction, perpendicular to the first and second directions.

12. The hinge according to claim 11, wherein the axial adjustment mechanism comprises a carriage connectable to the base and to the second hinge leaf, wherein the carriage is movable in the third direction.

13. The hinge according to claim 12, wherein the base comprises a housing having a guide channel and the carriage comprises a limiter located within the guide channel, the guide channel being configured to guide motion of the carriage relative to the housing in at least one direction.

14. The hinge according to claim 13, wherein the lateral adjustment recess is located in the limiter of the carriage, and wherein the lateral adjustment recess is elongate and configured to allow the shaft to move along a length of the lateral adjustment recess.

15. A door or window assembly comprising a door or window, a door or window frame and one or more hinges according to claim 1.
